(19) United States
(12) Patent Application Publication
(10) Pub. No.: US 2026/0112343 A1
(43) Pub. Date: Apr. 23, 2026

(54) INFORMATION PROCESSING METHOD AND INFORMATION PROCESSING SYSTEM

(71) Applicant: Yamaha Corporation, Hamamatsu (JP)

(72) Inventor: Akira MAEZAWA, Yokohama (JP)

(21) Appl. No.: 19/424,098

(22) Filed: Dec. 17, 2025

Related U.S. Application Data
(63) Continuation of application No. PCT/JP2024/019314, filed on May 27, 2024.

(30) Foreign Application Priority Data
Jun. 19, 2023 (JP) 2023-099954

(51) Int. Cl. G10H 1/00

(52) U.S. Cl. CPC G10H 1/0008; G10H 2210/091; G10H 2220/311

(57) ABSTRACT

An information processing method is realized by a computer system, and includes acquiring performance information relating to a performance of a musical instrument by a user, acquiring response information in natural language corresponding to the performance information, and executing a notification action for notifying the response information by a guide character displayed on a display device.

### CROSS-REFERENCE TO RELATED APPLICATIONS

This application is a continuation application of International Application No. PCT/JP2024/019314, filed on May 27, 2024, which claims priority to Japanese Patent Application No. 2023-099954 filed in Japan on Jun. 19, 2023. The entire disclosures of Japanese Patent Application No. 2023-099954 are hereby incorporated herein by reference.

### BACKGROUND

### Technical Field

The present disclosure generally relates to a technique for notifying a user of information relating to a performance of a musical instrument.

### Background Information

Techniques for notifying a user of information relating to a performance of a musical instrument have been proposed in the prior art. For example, Japanese Laid Open Patent Application No. 2022-053852 discloses a configuration in which video data generated by imaging carried out by a user are analyzed to generate performance information, and comparing the performance information with reference information is performed to generate an evaluation score.

### SUMMARY

However, if only the evaluation score is displayed as in the technique of Japanese Laid Open Patent Application No. 2022-053852, there is the problem that the user cannot easily and appropriately ascertain information on the user's own performance. In consideration of such circumstances, an object of one aspect of the present disclosure is to make it possible for the user to easily and appropriately understand information relating to the performance of a musical instrument.

In order to solve the problem described above, an information processing method according to one aspect of the present disclosure comprises acquiring performance information relating to a performance of a musical instrument by a user, acquiring response information in natural language corresponding to the performance information, and executing a notification action to notify the response information by a guide character displayed on a display device.

An information processing method according to another aspect of the present disclosure comprises acquiring performance information relating to a performance of a musical instrument by a user, and generating a prompt for causing a trained generative model to generate response information in natural language, the prompt including the performance information.

An information processing system according to one aspect of the present disclosure comprises an electronic controller including one or a plurality of processors. The electronic controller is configured to acquire performance information relating to a performance of a musical instrument by a user, acquire response information in natural language corresponding to the performance information, and cause a guide character displayed on a display device to execute a notification action for notifying the response information.

### BRIEF DESCRIPTION OF THE DRAWINGS

FIG. 1 is a block diagram showing a configuration of an information system according to a first embodiment.

FIG. 2 is a block diagram showing a configuration of an information processing system.

FIG. 3 is a schematic diagram of a settings screen.

FIG. 4 is a block diagram showing a functional configuration of the information processing system.

FIG. 5 is a schematic diagram of basic character strings.

FIG. 6 is a schematic diagram of a prompt and response information.

FIG. 7 is a schematic diagram of response information.

FIG. 8 is a schematic diagram of response information.

FIG. 9 is a schematic diagram of a guide character.

FIG. 10 is a flowchart of an evaluation notification process.

FIG. 11 is a schematic diagram of a prompt and response information according to a second embodiment.

FIG. 12 is a block diagram showing a functional configuration of an information processing system according to the second embodiment.

FIG. 13 is a flowchart of an evaluation notification process according to the second embodiment.

FIG. 14 is a schematic diagram of a prompt and response information according to a third embodiment.

FIG. 15 is a schematic diagram of a prompt and response information according to a modified example.

FIG. 16 is a schematic diagram of the prompt according to a modified example.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

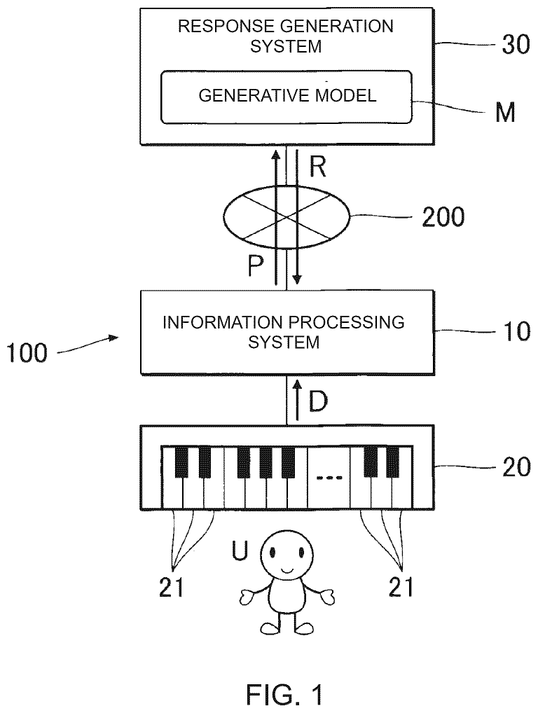

FIG. 1 is a block diagram showing a configuration of an information system 100 according to the first embodiment. The information system 100 is a computer system for guiding the performance of an electronic instrument 20 by a user U. The information system 100 comprises an information processing system 10, the electronic instrument 20, and a response generation system 30. The information processing system 10 can communicate with the response generation system 30 via a communication network 200, such as the Internet.

The response generation system 30 is a server system that generates response information R corresponding to a prompt P. The prompt P of the first embodiment is an action instruction expressed in natural language. The response information R is text data that express a response to the prompt P in natural language.

The response generation system 30 generates the response information R using a trained generative model M. The generative model M is a generative probability model that generates response information R corresponding to the prompt P. The generative model M has already learned the tendency of the response information R with respect to the prompt P through prior machine learning (pre-trained). Specifically, the generative model M is an interactive large language model (LLM) that is specifically trained for natural language processing tasks, such as response generation. For example, a natural language processing model realized by a transformer model using a self-attention mechanism is exemplified as the generative model M.

The electronic instrument 20 is an input device that receives a performance of a musical piece by the user U. The electronic instrument 20 of the first embodiment is a keyboard instrument conforming to the MIDI (Musical Instrument Digital Interface) standard, for example, and is provided with a plurality of keys 21 corresponding to various pitches. The electronic instrument 20 can be installed in the information processing system 10.

The user U sequentially operates the keys 21 to perform a musical piece. The electronic instrument 20 emits musical sounds corresponding to the performance by the user U, and also outputs, to the information processing system 10, a performance data sequence D representing said performance. The performance data sequence D is a time series of event data conforming to the MIDI standard, for example. Specifically, the performance data sequence D specifies, in chronological order, the pitches corresponding to the keys 21 operated by the user U.

The information processing system 10 transmits, to the response generation system 30, a prompt P corresponding to the result of evaluating the performance of the electronic instrument 20 by the user U, and notifies, to the user U, the response information R received from the response generation system 30. That is, the user U is notified of the response information R in natural language corresponding to the evaluation of the performance by the user U.

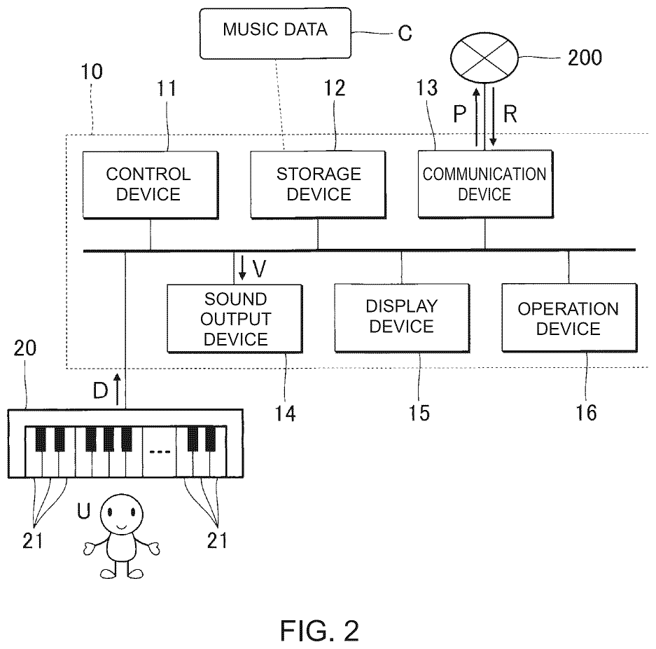

FIG. 2 is a block diagram of the information processing system 10. The information processing system 10 is realized by an information device such as a smartphone, a tablet terminal, or a personal computer. The information processing system 10 comprises a control device 11, a storage device 12, a communication device 13, a sound output device 14, a display device 15, and an operation device 16. Note that the information processing system 10 can be realized as a single device, or as a plurality of devices which are separately configured.

The control device (electronic controller) 11 includes one or a plurality of processors that control each element of the information processing system 10. For example, the control device 11 includes one or more types of processors, such as a CPU (Central Processing Unit), an SPU (Sound Processing Unit), a DSP (Digital Signal Processor), an FPGA (Field Programmable Gate Array), and an ASIC (Application Specific Integrated Circuit). The term “electronic controller” as used herein refers to hardware that executes software programs.

The storage device 12 includes one or more memory units (one or more computer memories) for storing a program that is executed by the control device 11 and various data that are used by the control device 11. The storage device 12 is a known storage medium, such as a magnetic storage medium or a semiconductor storage medium.

The storage device 12 can include a combination of a plurality of types of storage media. A portable storage medium that is attached to/detached from the information processing system 10, or a storage medium (for example, cloud storage) that the control device 11 can read from or write to via a communication network 200 can also be used as the storage device 12.

The storage device 12 stores music data C representing a musical piece played by the user U. The music data C are data representing a musical score of a musical piece. Specifically, the music data C specify the pitch and pronunciation period for each of a plurality of musical notes that constitute the musical piece. For example, the music data C are data conforming to the MIDI standard. The music data C can specify information such as performance symbols representing a musical expression.

The communication device 13 communicates with the response generation system 30 under the control of the control device 11. Specifically, the communication device 13 transmits a prompt P to the response generation system 30 and receives response information R transmitted from the response generation system 30.

The sound output device 14 emits a sound wave under the control of the control device 11. The sound output device 14 is, for example, a speaker or headphones. Specifically, a voice signal V representing voice (hereinafter referred to as “guidance voice”) corresponding to the response information R is supplied to the sound output device 14. The sound output device 14 reproduces the guidance voice to the user U. Illustrations of a D/A converter that converts the voice signal V from digital to analog and of an amplifier that amplifies the voice signal V have been omitted for the sake of convenience. Note that the sound output device 14 that is separate from the information processing system 10 can be connected to the information processing system 10 wirelessly or by wire.

The display device (display) 15 displays images under the control of the control device 11. The display device 15 is a display panel such as a liquid crystal panel or an organic electro-luminescence (EL) panel. The operation device 16 is an input device (user operable input) that receives instructions from the user U. For example, the operation device 16 is an operator operated by the user U, or a touch panel that detects touch by the user U. Note that the display device 15 or the operation device 16 that is separate from the information processing system 10 can be connected to the information processing system 10 wirelessly or by wire.

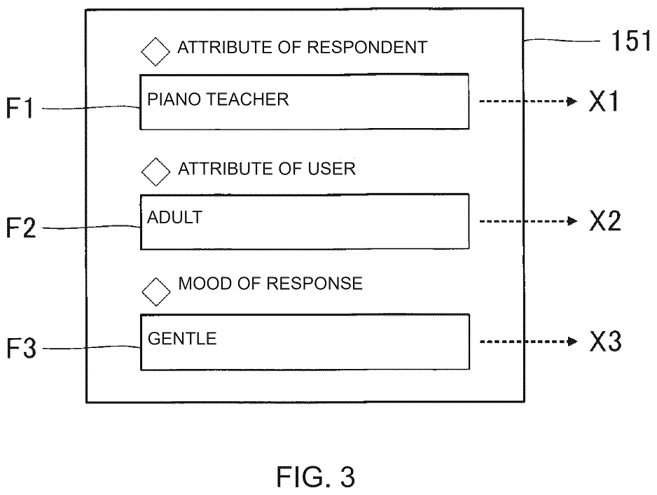

The user U can operate the operation device 16 to specify conditions (hereinafter referred to as “response conditions X”) relating to the response information R. FIG. 3 is a schematic diagram of a settings screen 151 used by the user U to instruct response conditions X (X1, X2, X3). The settings screen 151 is displayed on the display device 15. The response conditions X include an attribute X1 of a virtual respondent (for example, a guide character 152 described further below) that executes a response represented by the response information R, an attribute X2 of the user U, and a tone of voice X3 of the response according to the response information R. The settings screen 151 is an image in which a plurality of input fields F (F1, F2, F3) are arranged.

The input field F1 is an input box in which the user U specifies the attribute X1 of the virtual respondent. The user U operates the operation device 16 to input a character string of the attribute X1 of the respondent into the input field F1. For example, the occupation (piano teacher, etc.) of the respondent is input as the attribute X1. It should be noted that one of a plurality of options prepared in advance can be selected by the user U as the attribute X1.

The input field F2 is an input box in which the user U specifies the attribute X2 of the user U. The user U operates the operation device 16 to input a character string of the user's own attribute X2 into the input field F2. For example, the age group (elementary school student/junior high school student/high school student/college student/adult, etc.) of the user U is input as the attribute X2. It should be noted that one of a plurality of options prepared in advance can be selected by the user U as the attribute X2.

The input field F3 is an input box in which the user U specifies the tone of voice X3 of the response according to the response information R. The user U operates the operation device 16 to input a character string of the desired tone of voice X3 into the input field F3. For example, the tone of the utterance, such as “gentle,” “strict,” or “frank,” is specified as the tone of voice X3. It should be noted that one of a plurality of options prepared in advance can be selected by the user U as the tone of voice X3.

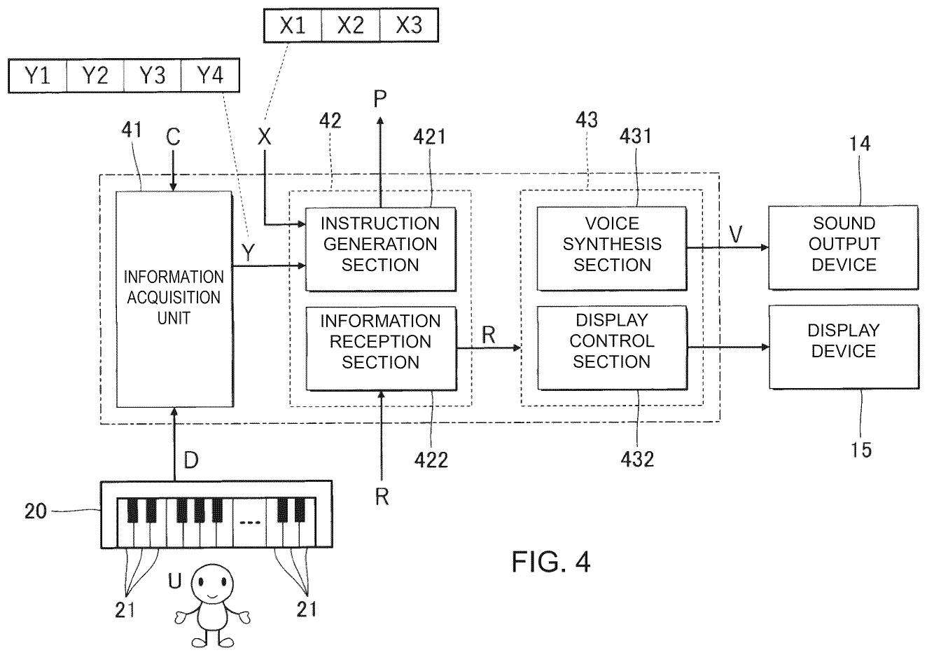

FIG. 4 is a block diagram illustrating a functional configuration of the information processing device 10. The control device 11 executes a program stored in the storage device 12 to realize a plurality of functions (information acquisition unit 41, response acquisition unit 42, action control unit 43).

The information acquisition unit 41 evaluates the performance of the electronic instrument 20 by the user U to acquire performance information. Specifically, the information acquisition unit 41 compares the performance data sequence D supplied from the electronic instrument 20 with the music data C stored in the storage device 12, and identifies differences between the two as performance errors made by the user U. That is, a performance error is the difference between the performance by the user U and a standard performance specified by the music data C. The information acquisition unit 41 generates, as the performance information, evaluation information Y for each performance error that occurs in the performance by the user U. The evaluation information Y is information representing an evaluation relating to the performance of the electronic instrument 20 by the user U. Specifically, the evaluation information Y includes importance Y1 of the performance error, position Y2 of the performance error, type Y3 of the performance error, and detailed content Y4 of the performance error.

The importance Y1 of the performance error is the degree of importance of the performance error. The importance Y1 in the first embodiment is binary information representing the level of importance. The importance Y1 can be information representing the degree of importance in multiple stages.

The position Y2 of the performance error is the location at which a performance error occurred in a musical piece. For example, a location of the musical piece at which the performance data sequence D and the music data C differ is identified as the position Y2 of the performance error. For example, the position is specified by the bar number in the musical piece, the elapsed time from the start of the musical piece, or the like. In addition to a specific point in time in a musical piece, a specific section in a musical piece can be specified as the position Y2 of a performance error.

The type Y3 of the performance error means a classification in which performance errors are distinguished according to type. For example, “pitch error,” “rhythm error,” “hesitation in performance,” or the like, is designated as the type Y3 of the performance error. The importance Y1 described above is set in accordance with the type Y3 of the performance error, for example. For example, the importance Y1 for each type Y3 of the performance error is stored in the storage device 12 in advance.

The detailed content Y4 of the performance error is the specific content of the performance error made by the user U, or of an indication regarding said performance error. For example, performance statuses such as “played ‘B’ when ‘C’ should be played,” “timing is earlier than the correct timing,” and “must play without stopping” are examples of the detailed content Y4 of the performance error. The detailed content Y4 of the performance error is expressed in natural language, for example.

The response acquisition unit 42 in FIG. 4 acquires response information R in natural language corresponding to the evaluation information Y. The response acquisition unit 42 of the first embodiment comprises an instruction generation section 421 and an information reception section 422. The instruction generation section 421 generates a prompt P for the response generation system 30. Specifically, the instruction generation section 421 generates a prompt P including response conditions X and evaluation information Y.

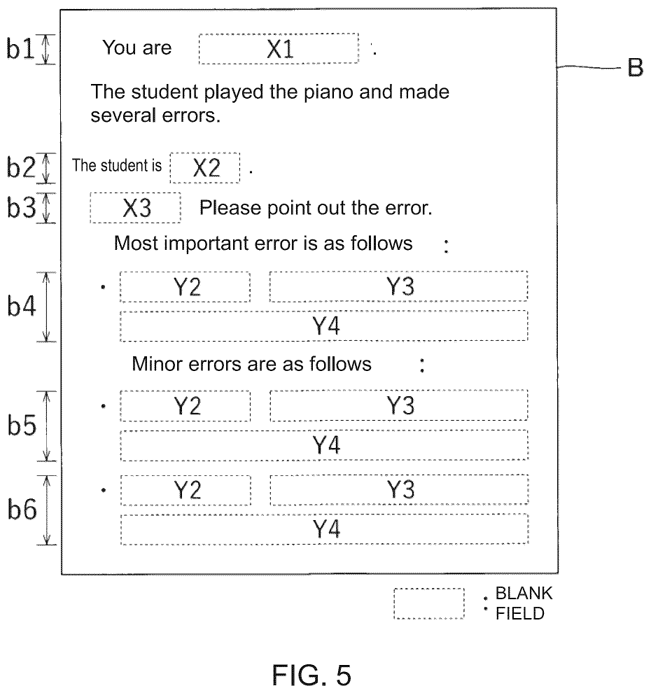

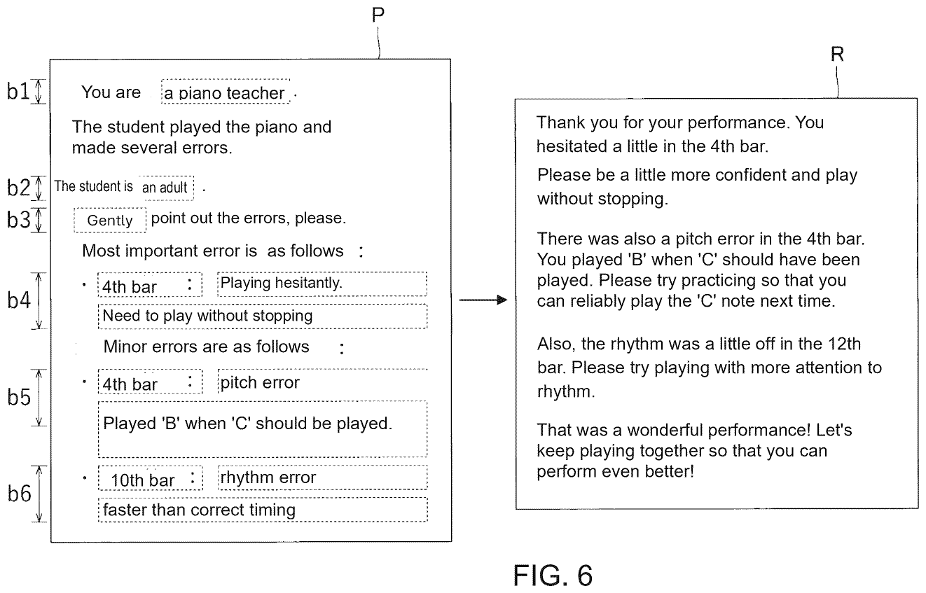

A basic character string B shown in FIG. 5 is used for the generation of the prompt P by the instruction generation section 421. The basic character string B is a template representing a typical character string of the prompt P, which is stored in the storage device 12 in advance. The basic character string B includes a plurality of character strings b1 to b6. A blank field is set in each of the plurality of character strings b1 to b6. Each blank field is a portion of the basic character string B in which variable information (response condition X, evaluation information Y) is inserted. The instruction generation section 421 inserts a response condition X or evaluation information Y in each blank field of the basic character string B to generate a prompt P. FIG. 6 illustrates a prompt P generated by the instruction generation section 421 using the basic character string B of FIG. 5.

The character string b1 of the basic character string B is a portion representing a condition relating to the respondent. The instruction generation section 421 inserts, into the blank field of the character string b1, the attribute X1 specified by the user U in the settings screen 151, thereby generating an instruction relating to the respondent in the prompt P. As described above, the prompt P of the first embodiment includes the attribute X1 of a virtual respondent.

The character string b2 of the basic character string B is a portion representing a condition of the user U to whom the response information R is to be notified. The instruction generation section 421 inserts, into the blank field of the character string b2, the attribute X2 specified by the user U in the settings screen 151, thereby generating an instruction relating to the user U in the prompt P. As described above, the prompt P of the first embodiment includes the attribute X2 of the user U.

The character string b3 of the basic character string B is a portion representing a condition relating to the expression of the response according to the response information R. The instruction generation section 421 inserts, into the blank field of the character string b3, the tone of voice X3 specified by the user U in the settings screen 151, thereby generating an instruction relating to the expression of the response information R in the prompt P. As described above, the prompt P of the first embodiment includes the tone of voice X3 relating to the response information R.

The character strings b4 to b6 of the basic character string B are portions representing conditions relating to the content of the response according to the response information R. The instruction generation section 421 inserts, into the blank field of the each of the character strings b4 to b6, the evaluation information Y generated by the information acquisition unit 41, thereby generating instructions relating to the content of the response information R in the prompt P.

The character string b4 is a portion notifying a major performance error. The instruction generation section 421 inserts, into each of the blank fields of the character string b4, the position Y2, the type Y3, and the detailed content Y4 specified by each piece of evaluation information Y with high importance Y1, thereby generating an instruction relating to a major performance error in the prompt P.

The character string b5 and the character string b6 are portions notifying minor performance errors. The instruction generation section 421 inserts, into each of the blank fields of the character string b5 and character string b6, the position Y2, the type Y3, and the detailed content Y4 specified by each piece of evaluation information Y with low importance Y1, thereby generating instructions relating to minor performance errors in the prompt P. The number of performance errors specified in the prompt P can vary.

The instruction generation section 421 in FIG. 4 transmits the prompt P generated by the procedure described above from the communication device 13 to the response generation system 30. The response generation system 30 processes the prompt P received from the information processing system 10 using the generative model M to generate response information R in natural language, and transmits the response information R to the information processing system 10. The information reception section 422 in FIG. 4 receives the response information R transmitted from the response generation system 30 with the communication device 13. That is, the information reception section 422 acquires the response information R generated by the trained generative model M in response to the prompt P.

FIG. 6 illustrates the response information R generated from the above-mentioned prompt P. The response information R represents a natural language response that reflects the response conditions X and the evaluation information Y included in the prompt P. Specifically, the response information R represents a response sentence in natural language that should be uttered using the tone of voice X3 by the respondent with the attribute X1 to the user U with the attribute X2. In addition, the response information R represents the response sentence in natural language that explains to the user U the performance error represented by the evaluation information Y. Specifically, in the response information R, a major performance error and minor performance errors are distinguished (importance Y1), and the position Y2, the type Y3, and the detailed content Y4 of the performance errors are indicated.

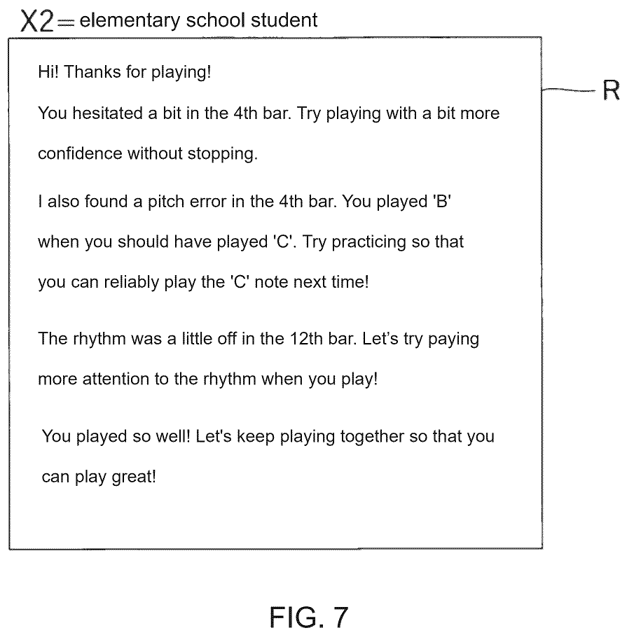

In FIG. 6, the attribute X2 of the user U is “adult,” whereas FIG. 7 illustrates an example of the response information R in which the attribute X2 is “elementary school student.” When the attribute X2 of the user U is “adult” (FIG. 6), the response information R is generated in a polite tone, like a conversation between adults. On the other hand, when the attribute X2 is “elementary school student” (FIG. 7), the response information R is generated in a friendly and approachable tone, like an adult instructing a child. As described above, in the first embodiment, since the attribute X2 of the user U is included in the prompt P, a variety of response information R can be generated in accordance with the attribute X2 of the user U. Similarly, in the first embodiment, since the attribute X1 of a virtual respondent is included in the prompt P, a variety of response information R can be generated in accordance with the attribute X1 of the respondent.

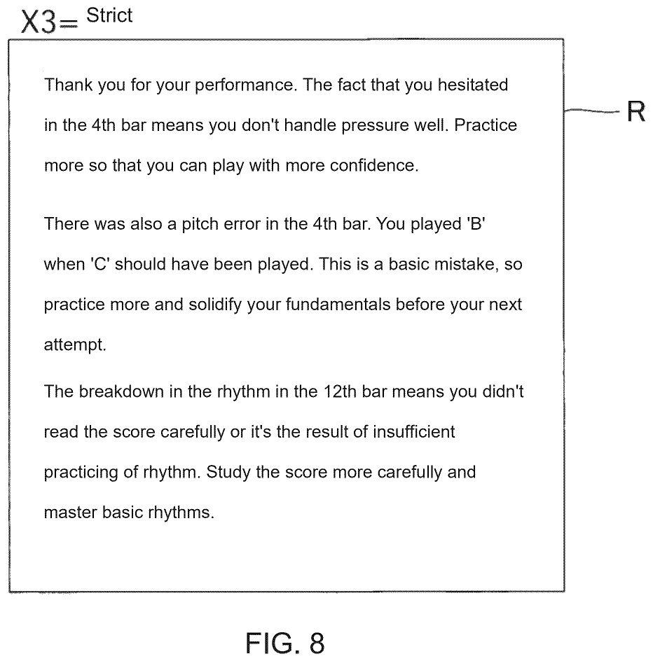

In addition, in FIG. 6, the tone of voice X3 is “gentle,” whereas FIG. 8 illustrates an example of the response information R when the tone of voice X3 is “strict.” When the tone of voice X3 is “gentle” (FIG. 6), the response information R is generated in a gentle tone so as not to hurt the self-esteem of the user U. On the other hand, when the tone of voice X3 is “strict” (FIG. 8), the response information R is generated in a strict tone. As described above, in the first embodiment, since the tone of voice X3 relating to the response information R is included in the prompt P, the response information R can be generated with a variety of tones of voice.

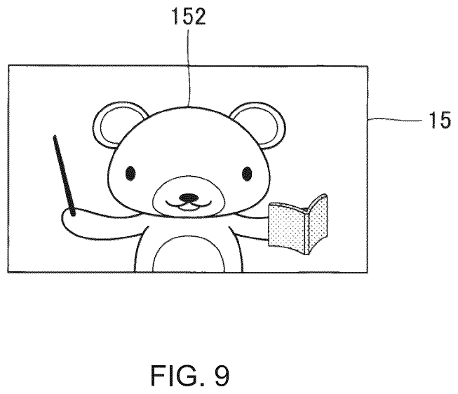

The action control unit 43 of FIG. 4 executes an action (hereinafter referred to as “notification action”) for notifying the user U of the response information R described above. The notification action of the first embodiment is an action for notifying the user U of the response information R by guide character 152 (FIG. 9) displayed on the display device 15. The action control unit 43 of the first embodiment comprises a voice synthesis section 431 and a display control section 432.

The voice synthesis section 431 generates a voice signal V of a guidance voice corresponding to the response information R. A guidance voice is a voice that reads a response sentence represented by the response information R. Specifically, the voice synthesis section 431 executes a voice synthesis process on the response information R to generate the voice signal V. Examples of the voice synthesis process include a concatenative voice synthesis process, which connects a plurality of voice elements, and a statistical model type voice synthesis process that uses a statistical model such as a deep neural network or a Hidden Markov Model (HMM). The voice synthesis section 431 supplies the voice signal V to the sound output device 14. Accordingly, a guidance voice represented by the voice signal V is reproduced from the sound output device 14.

The display control section 432 displays the guide character 152 of FIG. 9 on the display device 15. The guide character 152 is an object (agent) placed inside a virtual space, and a graphical representation of a character or an agent displayed on a display device (display) in a digital environment. Specifically, the guide character 152 is a virtual instructor that instructs the performance of the electronic instrument 20 by the user U in the virtual space.

The display control section 432 causes the guide character 152 to execute a speaking action in parallel with the reproduction of the guidance voice by the sound output device 14. A speaking action is an action in which the shape of the mouth of the guide character 152 is changed in accordance with the voice signal (so-called lip-syncing). The notification action of the first embodiment includes reproduction of the guidance voice and the speaking action of the guide character 152. By executing the speaking action and reproduction of the guidance voice in parallel, it is possible to cause the user U to perceive the sensation as if the guide character 152 is instructing the user U.

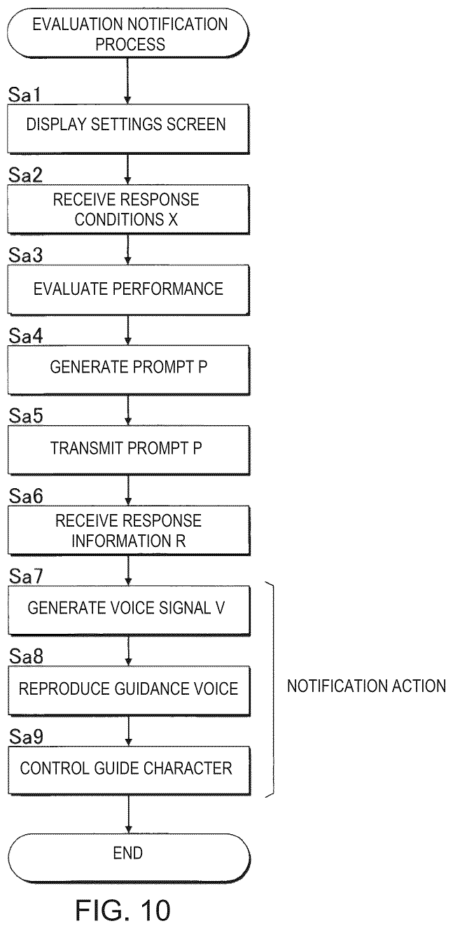

FIG. 10 is a flowchart of the process (hereinafter referred to as “evaluation notification process”) that is executed by the control device 11. For example, the evaluation notification process is triggered by an instruction from the user U issued to the operation device 16.

When the evaluation notification process is started, the control device 11 (response acquisition unit 42) displays the settings screen 151 of FIG. 3 on the display device 15 (Sa1). The control device 11 (response acquisition unit 42) receives, from the user U, an input of the response conditions X (X1, X2, X3) on the settings screen 151 (Sa2). The response conditions X received from the user U are stored in the storage device 12.

After inputting the response conditions X, the user U starts to play the electronic instrument 20. The control device 11 (information acquisition unit 41) acquires performance information relating to the performance of the electronic instrument 20 by the user U. In this embodiment, the control device 11 evaluates the performance of the electronic instrument 20 by the user U (Sa3). Specifically, the control device 11 generates the evaluation information Y, as the performance information, for each performance error that occurs during the performance by the user U.

The control device 11 (instruction generation section 421) generates a prompt P including the response conditions X and the evaluation information Y (Sa4). Specifically, the control device 11 inserts the response conditions X (X1, X2, X3) and the evaluation information Y (Y2, Y3, Y4) into each blank field of the basic character string B stored in the storage device 12 to generate the prompt P.

The control device 11 (instruction generation section 421) transmits the prompt P to the response generation system 30 via the communication device 13 (Sa5). That is, the control device 11 requests the response generation system 30 to generate the response information R. The control device 11 (information reception section 422) receives the response information R generated and transmitted by the response generation system 30 with the communication device 13 (Sa6).

The control device 11 (voice synthesis section 431) generates a voice signal V representing a guidance voice corresponding to the response information R, and outputs the voice signal V to the sound output device 14 (Sa8). In parallel with the output of the sound signal V to the sound output device 14, the control device 11 (display control section 432) causes the guide character 152 displayed on the display device 15 to execute a speaking action (Sa9). That is, a notification action including reproduction of the guidance voice (Sa7, Sa8) and a speaking action (Sa9) by the guide character 152 are executed.

As described above, in the first embodiment, the response information R in natural language corresponding to the evaluation information Y relating to the performance of the musical instrument 20 is acquired, and the guide character 152 executes a notification action for notifying the response information R. Accordingly, for example, compared to a configuration for displaying a numerical value (for example, an evaluation score) obtained by evaluating a performance of the electronic instrument 20 by the user U, the user U can readily and appropriately understand the evaluation of the performance of the musical instrument 20. In addition, the user U can be provided with a unique customer experience of enjoying the sensation of being instructed how to play the electronic instrument 20 by the guide character 152.

In addition, in the first embodiment, the prompt P is generated including the evaluation information Y relating to the performance of the electronic instrument 20 by the user U, and the response information R in natural language generated by the trained generative model M in response to the prompt P is acquired. Accordingly, it is possible to notify the user U of a statistically valid and linguistically natural response information R, with respect to the evaluation (evaluation information Y) relating to the performance of the electronic instrument 20 by the user U. In particular, in the first embodiment, the evaluation information Y includes various information (importance Y1, position Y2, type Y3, and detailed content Y4) relating to the performance error, so that it is possible to generate the response information R that includes various information relating to performance errors made by the user U.

### B: Second Embodiment

The second embodiment will be described. In each of the embodiments illustrated below, elements that have the same functions as those in first embodiment have been assigned the same reference symbols used to describe the first embodiment and detailed descriptions thereof have been appropriately omitted.

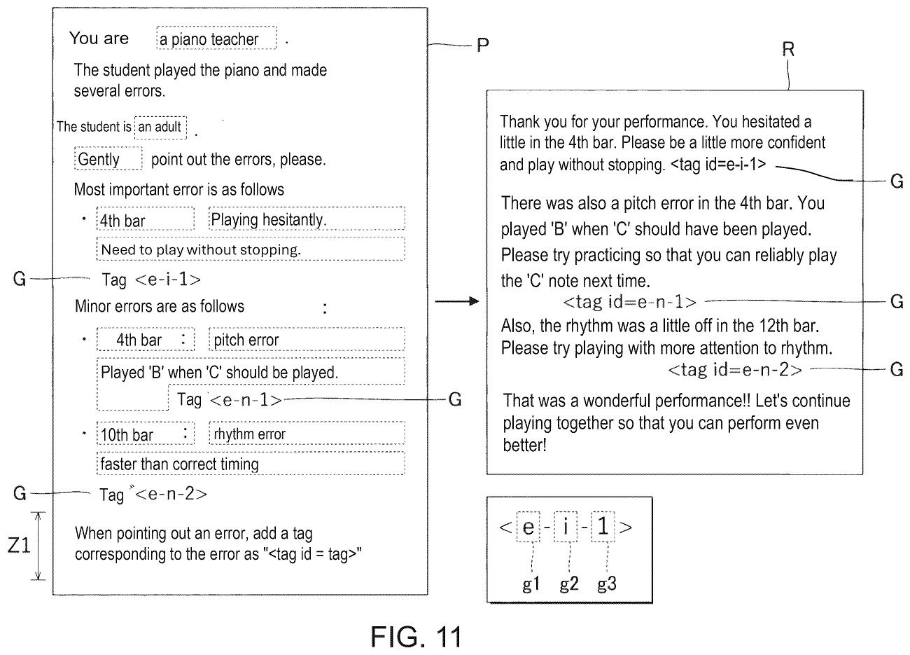

FIG. 11 is a schematic diagram of a prompt P and response information R in a second embodiment. In addition to the same elements as in the first embodiment, the prompt P of the second embodiment includes identification information G for each performance error, and an instruction Z1 to include the identification information G for each performance error in the response information R.

The identification information G is a code string (tag) for identifying each performance error represented by the evaluation information Y. Specifically, the identification information G includes a code g1 representing a performance error, a code g2 corresponding to the importance Y1, and a number g3 assigned to the performance error.

The code g2 is set to “i” when the importance Y1 is high, and to “n” when the importance Y1 is low. On the other hand, the instruction Z1 is in natural language indicating that the identification information G is to be added to the portion of the response information R that indicates each performance error.

FIG. 11 illustrates the response information R generated from the prompt P described above. As can be understood from FIG. 11, as a result of the prompt P including the instruction Z1 being processed by the generative model M, response information R including the identification information G is generated. That is, the response information R is generated in accordance with the instruction Z1. Specifically, the identification information G of each performance error is set immediately after the portion of the response information R that indicates said performance error.

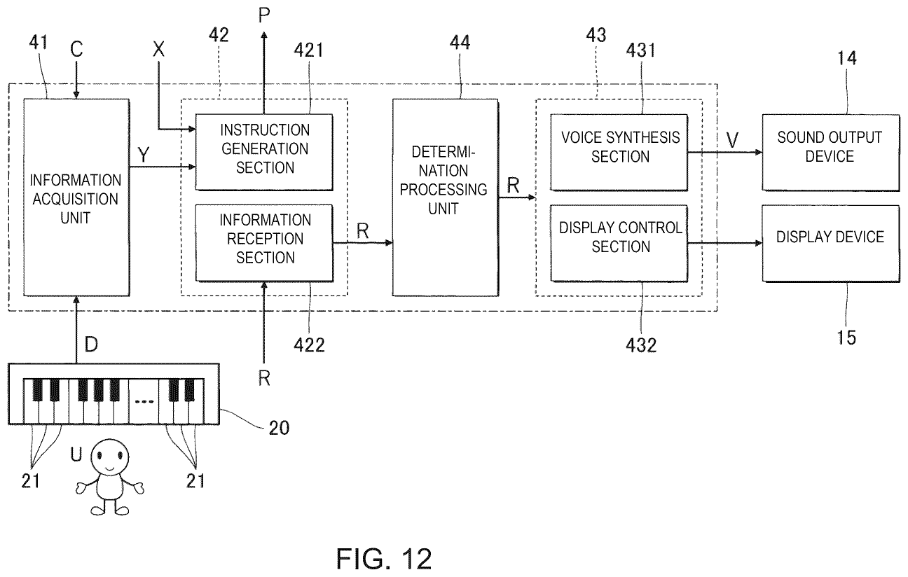

FIG. 12 is a block diagram showing a functional configuration of an information processing system 10 according to the second embodiment. The control device 11 of the second embodiment executes a program stored in the storage device 12 to function as a determination processing unit 44, in addition to the same functions as in the first embodiment (information acquisition unit 41, response acquisition unit 42, action control unit 43). The determination processing unit 44 determines the appropriateness of the response information R. The operations of the components other than the determination processing unit 44 are the same as those of the first embodiment.

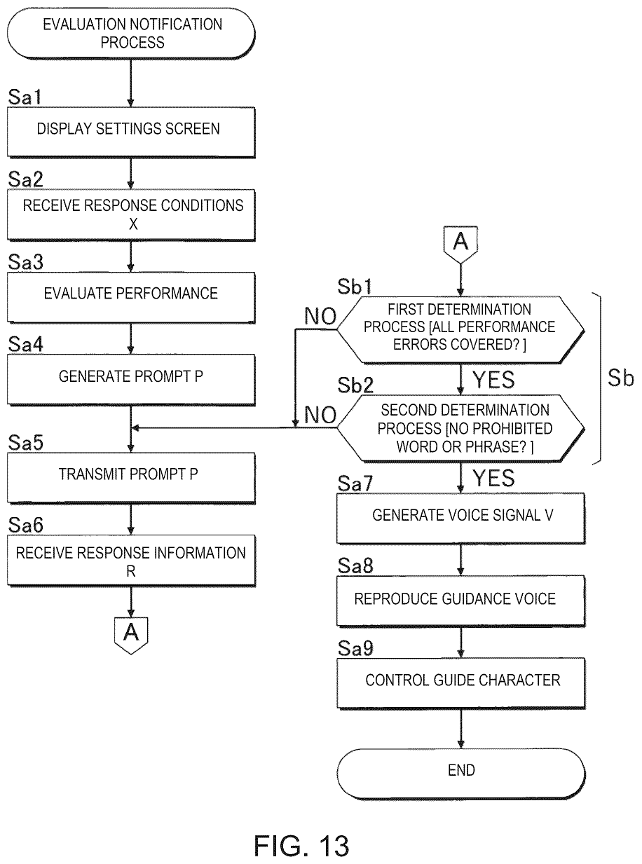

FIG. 13 is a flowchart of an evaluation notification process in the second embodiment. The process from the start of the evaluation notification process to the acquisition of the response information R (Sb6) is the same as that in the first embodiment. When the response information R is acquired, the control device 11 (determination processing unit 44) executes a determination process Sb for determining the appropriateness of the response information R. The determination process Sb of the second embodiment includes a first determination process Sb1 and a second determination process Sb2. The order of the first determination process Sb1 and the second determination process Sb2 can be reversed.

The first determination process Sb1 determines whether the response information R is appropriate with respect to the prompt P. Specifically, the determination processing unit 44 determines whether all of the performance errors specified in the prompt P are mentioned in the response information R.

For example, the determination processing unit 44 compares the prompt P transmitted to the response generation system 30 with the response information R generated from said prompt P to determine whether all of the identification information G of the performance errors included in the prompt P is also included in the response information R. If all of the identification information G is included in the response information R, the result of the first determination process Sb1 is affirmative. On the other hand, if some of the identification information G included in the prompt P is not included in the response information R, the result of the first determination process Sb1 is negative.

The second determination process Sb2 is a process for determining whether the response information R contains a prohibited word or phrase. A prohibited word or phrase is an inappropriate word or phrase from an educational or social perspective. A plurality of prohibited words and phrases are stored in the storage device 12 in advance. Prohibited words and phrases can be set in accordance with an operation of the user U on the operation device 16.

Specifically, the determination processing unit 44 determines whether the response information R contains any of a plurality of prohibited words and phrases stored in the storage device 12. If the response information R does not contain a prohibited word or phrase, the result of the second determination process Sb2 is affirmative (the response information R is appropriate). On the other hand, if the response information R contains a prohibited word or phrase, the result of the second determination process Sb2 is negative (the response information R is inappropriate).

If the results of both the first determination process Sb1 and the second determination process Sb2 are affirmative, the response information R is appropriate. Accordingly, the control device 11 (action control unit 43) executes a notification action including reproduction of the guidance voice (Sa7, Sa8) and a speaking action (Sa9) by the guide character 152, in the same manner as in the first embodiment. That is, the control device 11 executes a notification action when the response information R is determined to be appropriate. In the generation of the sound signal V (Sa7), the identification information G of the response information R is not included in the guidance voice. That is, the identification information G is excluded from the target of voice synthesis by the voice synthesis section 431.

On the other hand, if the result of either the first determination process Sb1 or the second determination process Sb2 is negative, the response information R is inappropriate. Accordingly, the response information R is regenerated. Specifically, the control device 11 (instruction generation section 421) re-transmits the prompt P generated in the immediately preceding step Sa4 from the communication device 13 to the response generation system 30 (Sa5).

The response generation system 30 processes, using the generative model M, the prompt P received from the information processing system 10 to generate the response information R. Even if the prompt P is the same, the response information R generated by the generative model M changes for each generation. That is, a response information R that is different from the response information R determined to be inappropriate by the control device 11 is generated.

The control device 11 (information reception section 422) receives the response information R generated and transmitted by the response generation system 30 with the communication device 13 (Sa6). As can be understood from the foregoing explanation, transmission of the prompt P (Sb5) and reception of the response information R (Sb6) are repeated until the response information R is determined to be appropriate in the determination process Sb.

The same effects as those of the first embodiment are realized in the second embodiment. In addition, in the second embodiment, the notification action is executed when the response information R is determined to be appropriate. Accordingly, compared to a configuration in which the notification action is unconditionally executed, the possibility that an inappropriate response information R is notified to the user U can be reduced.

In addition, in the second embodiment, the response information R including the identification information G of the performance error is generated by the generative model M. Accordingly, it is possible to easily check, using the identification information G, whether all of the performance errors specified in the prompt P are included in the response information R.

### C: Third Embodiment

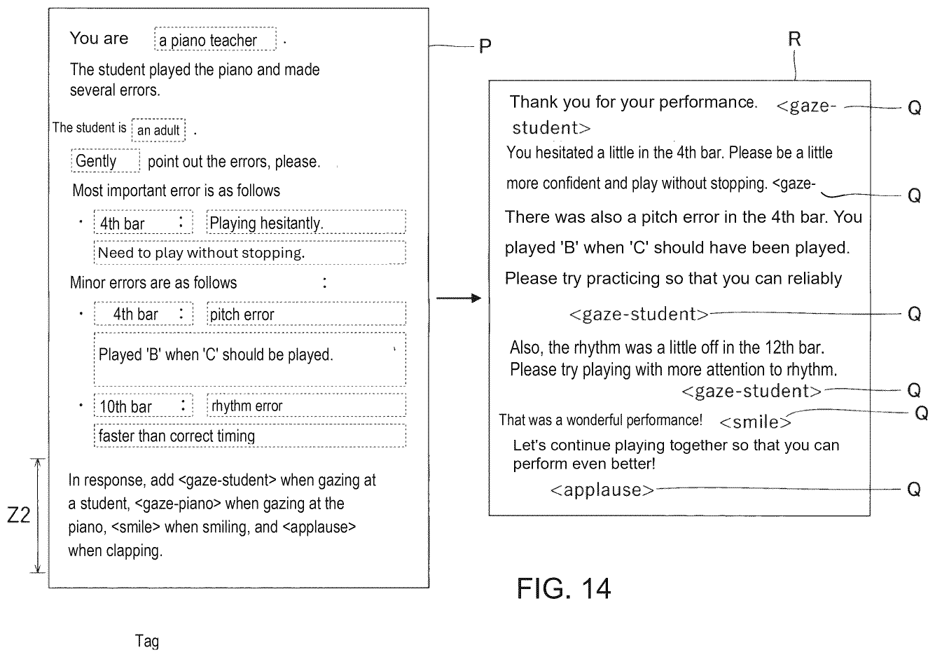

FIG. 14 is a schematic diagram of a prompt P and response information R according to a third embodiment. In addition to the same elements as in the first embodiment, the prompt P of the third embodiment includes an instruction Z2 to include action information Q in the response information R. The action information Q is information (tag) for identifying the action that should be executed in the process of notifying the response information R. Specifically, the instruction Z2 includes a natural language phrase representing the action that should be executed in the process of notifying the response information R, and action information Q representing said action. Examples of phrases that represent an action include “when gazing at student,” “when gazing at a piano,” “when smiling,” and “when clapping.” The action information Q is identification information for identifying each action.

FIG. 14 illustrates the response information R generated from the prompt P described above. As can be understood from FIG. 14, as a result of a prompt P including an instruction Z2 being processed by a generative model M, response information R including action information Q is generated. That is, response information R is generated in accordance with the instruction Z2.

Specifically, action information Q of each action is set to the portion of the response information R where said action should be executed. For example, at the beginning of the response information R, action information Q of an action of gazing at the user U (=<gaze-student>) is set, and immediately after a portion of the response information R indicating a performance error, action information Q of an action of gazing at the user U (=<gaze-student>) or action information Q of an action of gazing at the piano (=<gaze-piano>) is set. In addition, at the end of the response information R, action information Q of an action of smiling (=<smile>) and action information Q of an action of clapping (=<applause>) are set. As can be understood from the foregoing explanation, the response information R of the third embodiment specifies the action that should be executed in the process of notifying the response information R.

The procedure of the evaluation notification process is the same as that in the first embodiment, except for the control of the guide character 152 (Sa9). In step Sa9 of the evaluation notification process, the control device 11 (display control section 432) causes the guide character 152 to execute the action specified in the response information R. Specifically, at a time point at which a guidance voice of a portion of the response information R near action information Q is reproduced, the control device 11 causes the guide character 152 to execute the action represented by said action information Q.

For example, in parallel with the reproduction of the beginning of the guidance voice, the guide character 152 executes an action of gazing at the user U (Q=<gaze-student>). Immediately after the portion of the guidance voice that indicates a performance error, the guide character 152 executes an action of gazing at the user U (Q=<gaze-student>) or an action of gazing at the piano (Q=<gaze-piano>). When the guidance voice is reproduced to the end, the guide character 152 executes an action of smiling (Q=<smile>) and an action of clapping (Q=<applause>). The action information Q of the response information R is not included in the guidance voice. That is, the action information Q is excluded from the target of voice synthesis by the voice synthesis section 431.

The same effects as those of the first embodiment are realized in the third embodiment. In addition, in the third embodiment, the guide character 152 executes various actions in the notification action. Accordingly, it is possible to diversify the actions of the guide character 152. In the description above, the third embodiment is described based on the first embodiment but the configuration of the second embodiment for determining appropriateness of the response information R also can be applied to the third embodiment.

### D: Modified Example

Specific modified embodiments to be added to each of the embodiments exemplified above are illustrated below. Two or more embodiments arbitrarily selected from the following examples can be appropriately combined insofar as they are not mutually contradictory.
(1) In each of the above-mentioned embodiments, the attribute X1 of the respondent, the attribute X2 of the user U, and the tone of voice X3 of the response are exemplified as the response conditions X, but the response conditions X are not limited to the examples described above. For example, the language of the response can be specified as a response condition X. The response information R is expressed using the language specified as the response condition X.

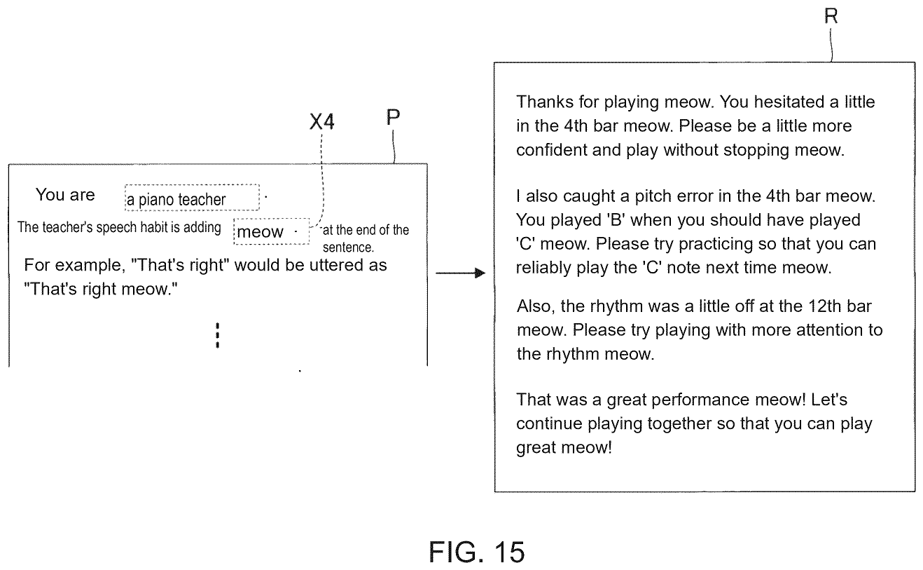

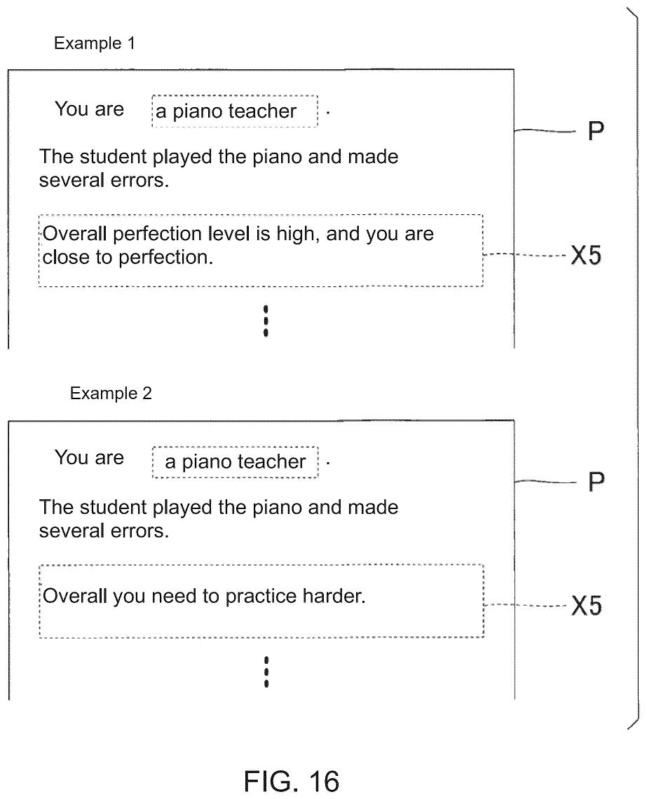

In addition, a speech habit X4 of the response in the response information R can be specified as a response condition X. FIG. 15 illustrates a prompt P that specifies the speech habit X4 “meow” as a response condition X, and response information R that is generated in accordance with said prompt P. Response information R is generated in which the speech habit X4 specified as a response condition X is added to the end of each sentence. The tone of voice X3 and the speech habit X4 can be collectively interpreted as being the tone of voice (tone of speech) of the response. In addition, as shown in FIG. 16, an overall evaluation X5 of the result of evaluating the performance of the electronic instrument 20 by the user U can be included in the response conditions X. The response sentence represented by the response information R changes in accordance with the overall evaluation X5.
(2) In each of the above-mentioned embodiments, the evaluation information Y is generated for each performance error made by the user U, but the evaluation information Y is not limited to information representing a performance error. For example, the evaluation information Y can represent good points (highly-evaluated points) of the performance by the user U. According to a prompt P that includes evaluation information Y of highly-evaluated points, response information R praising the performance of the user U is generated. In addition, in the evaluation information Y, each of the importance Y1, the position Y2, the type Y3, and the detailed content Y4 can be omitted.
(3) In each of the above-mentioned embodiments, a configuration is exemplified in which the user U selects the response conditions X (X1, X2, X3), but the method of setting the response conditions X is not limited to the example described above. For example, the response conditions X can be stored for each guide character 152 in the storage device 12 in advance. For example, the user U operates the operation device 16 to select one of a plurality of guide characters 152. The response acquisition unit 42 (instruction generation section 421) generates a prompt P that includes, from among the plurality of response conditions X stored in the storage device 12, response conditions X corresponding to the guide character 152 selected by the user U. According to the embodiment described above, the workload of the user U relating to the setting of the response conditions X can be reduced.
(4) In the second embodiment, a configuration is exemplified in which a transmitted prompt P is re-transmitted when the response information R is inappropriate, but the action to be taken when the response information R is inappropriate is not limited to the example described above. For example, the control device 11 (instruction generation section 421) can edit the transmitted prompt P following a prescribed rule and transmit the edited prompt P. For example, if the response information R is determined to be inappropriate due to containing a prohibited word or phrase, a prompt P in which not containing said prohibited word or phrase is added as a condition is generated by the instruction generation section 421. In addition, the control device 11 (response acquisition unit 42) can display, on the display device 15, a message to the effect that the response information R is inappropriate.
(5) In the second embodiment, the method of the determination process Sb for determining the appropriateness of the response information R is not limited to the example described above. For example, the first determination process Sb1 that uses the identification information G can be omitted. That is, in a configuration in which the determination processing unit 44 determines the appropriateness of the response information R, the identification information G of the response information R and the prompt P are not essential.
(6) In each of the embodiments described above, an example is shown in which the importance Y1 is set in accordance with the type Y3 of the performance error, but the method of setting the importance Y1 is not limited to the example described above. Specifically, the information acquisition unit 41 can set the importance Y1 in accordance with a history of past performances by the user U. For example, a performance error that occurs frequently in the performances of the user U tends to be of high importance and high priority for improvement. In consideration of the tendency described above, the information acquisition unit 41 sets a large value to the importance Y1 of a performance error that occurs frequently in past performances of the user U.
(7) In each of the above-mentioned embodiments, the prompt P including the response conditions X and the evaluation information Y is exemplified, but the content of the prompt P is not limited to the example described above. For example, it is possible to conceive a configuration in which either the response conditions X or the evaluation information Y is omitted, or a configuration in which information other than the response conditions X and the evaluation information Y is included in the prompt P.
(8) In each of the embodiments described above, a configuration is exemplified in which the process of acquiring (Sa6) the response information R, etc., is executed after the performance of the musical piece by the user U ends, but the evaluation of the performance (Sa3), acquisition of the response information R (Sa4 to Sa6) and the notification action (Sa7 to Sa9) can be executed in parallel with the performance of the musical piece by the user U.

For example, the process described above can be executed for each of a plurality of unit time intervals obtained by dividing a musical piece on a time axis. A unit time interval is, for example, a structural period into which a musical piece is divided in accordance with musical meaning. Structural periods are periods such as intro, verse, bridge, chorus, and outro.

In addition, evaluation of a performance of a musical piece by the user U can be executed in parallel with said performance, and the acquisition of the response information R (Sa4 to Sa6) and the notification action (Sa7 to Sa9) can be executed each time a performance error occurs (that is, each time evaluation information Y is generated).
(9) In each of the above-mentioned embodiments, a configuration is exemplified in which the guide character 152 notifies the user U of the response information R, but the display of the guide character 152 can be omitted. For example, a configuration is conceivable in which the response information R is notified to the user U only by reproduction of the guidance voice represented by the voice signal V. That is, the display control section 432 can be omitted from the action control unit 43.

In addition, in each of the embodiments described above, a configuration is exemplified in which the guidance voice represented by the response information R is reproduced, but the method by which the response information R is notified to the user U (notification action) is not limited to the example described above. For example, the notification action can be an action of displaying, on the display device 15, a response sentence represented by the response information R, or an action of printing, using a printing device, a response sentence represented by the response information R. An action of transmitting the response information R to a terminal device owned by the user U is also an example of a notification action.

In addition, the action control unit 43 can display, on the display device 15, a musical score represented by the music data C, and highlight locations in the musical score corresponding to the performance errors represented by the response information R. The action control unit 43 can display, on the display device 15, a note played by the user U due to a performance error and the correct note represented by the music data C in comparison with each other. Additionally, the action control unit 43 can cause the guide character 152 to execute an action of indicating the location in the musical score corresponding to a performance error. The action control unit 43 can reproduce, with the sound output device 14, the performance of the location of the musical piece represented by the music data C corresponding to the performance error represented by the response information R. As illustrated above, “notification action” encompasses any action for notifying the user U of the response information R.
(10) In each of the above-mentioned embodiments, a configuration is exemplified in which the information acquisition unit 41 evaluates the performance of the electronic instrument 20 by the user U, but the information acquisition unit 41 can receive, with the communication device 13, evaluation information Y generated by an external device. For example, in a configuration in which the electronic instrument 20 generates evaluation information Y, the information acquisition unit 41 receives, with the communication device 13, the evaluation information Y transmitted from the electronic instrument 20. As can be understood from the foregoing explanation, the information acquisition unit 41 is comprehensively expressed as an element that acquires evaluation information Y relating to the performance of the electronic instrument 20 by the user U. In addition to “generation” of the evaluation information Y (that is, evaluation of a performance), “acquisition” of the evaluation information Y also encompasses “reception” of the evaluation information Y.
(11) In each of the above-mentioned embodiments, a configuration is exemplified in which the response generation system 30 that is separate from the information processing system 10 generates the response information R, but the information processing system 10 can generate the response information R. For example, the generative model M can be installed in the information processing system 10. The response acquisition unit 42 processes, using the generative model M, the prompt P generated by the instruction generation section 421 to generate the response information R. As can be understood from the foregoing explanation, the response acquisition unit 42 is comprehensively expressed as an element that acquires the response information R. In addition to “reception” of the response information R, “acquisition” of the response information R also encompasses “generation”of the response information R.
(12) In each of the above-mentioned embodiments, evaluation information Y representing an evaluation relating to the performance by the user U is exemplified, but the information (performance information) acquired by the information acquisition unit 41 is not limited to the evaluation information Y. For example, text data relating to the status of the performance by the user U are also exemplified as performance information. Text data which are an example of performance information are, for example, the type of the musical instrument played by the user U, the name of the note played by the user U, and the like. That is, an evaluation of the performance (evaluation information Y) is not essential for the generation of the performance information.

In addition, for example, video data generated by an imaging device by photographing a performance by the user U, and audio data generated by a sound collection device by collecting musical sounds produced by a performance by the user U, are exemplified as performance information. A combination of two or more types of information described above can be acquired as performance information by the information acquisition unit 41.

As can be understood from the examples described above, “performance information” is comprehensively expressed as information relating to the performance by the user U, and evaluation information Y, text data, video data, and audio data are examples of “performance information.”
(13) In each of the above-mentioned embodiments, a keyboard instrument is illustrated as an example of the electronic instrument 20, but the musical instrument to be the subject of performance evaluation is not limited to a keyboard instrument. For example, each of the above-mentioned embodiments can be similarly applied to any type of musical instrument, such as a string instrument, a wind instrument, or a percussion instrument.

In each of the above-mentioned embodiments, the electronic instrument 20 that can generate a performance data sequence D is illustrated as an example, but the musical instrument to be the subject of performance evaluation is not limited to the electronic instrument 20. For example, each of the above-mentioned embodiments can be similarly applied to the evaluation of the performance of a natural musical instrument. In a configuration in which the user U plays a natural musical instrument, the information acquisition unit 41 analyzes audio signals generated by collecting sounds emitted from the natural musical instrument to generate the evaluation information Y. Any known technique can be employed for the performance evaluation.

In addition, the subject of evaluation is not limited to a performance of a musical instrument. For example, each of the above-mentioned embodiments can be similarly applied to a configuration for evaluating singing by the user U. For example, the information acquisition unit 41 analyzes audio signals generated by collecting sounds of a singing voice to generate the evaluation information Y. Any known technique can be employed for the evaluation of singing.
(14) As described above, the functions of the information processing system 10 used as an example above are realized by cooperation between one or more processors that constitute the control device 11, and a program stored in the storage device 12. The program according to the present disclosure can be provided in a form stored in a computer-readable storage medium and installed on a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium excluding transitory propagating signals and does not exclude volatile storage media. In addition, in a configuration in which a distribution device distributes the program via a communication network, a storage medium that stores the program in the distribution device corresponds to the non-transitory storage medium.

### E: Additional Statement

For example, the following configurations can be understood from the embodiments exemplified above.

An information processing method according to one aspect (aspect 1) of the present disclosure comprises acquiring performance information relating to a performance of a musical instrument by a user, acquiring response information in natural language corresponding to the performance information, and executing a notification action to notify the response information by a guide character displayed on a display device. According to the aspect described above, response information in natural language corresponding to the performance information relating to the performance of a musical instrument is acquired, and a guide character executes a notification action for notifying the response information. Accordingly, compared to a configuration for displaying a numerical value (for example, an evaluation score) relating to the performance of a musical instrument by the user, the user can readily and appropriately understand the information relating to the performance of the musical instrument. In addition, the user can be given the sensation of being guided (for example, instructed) on how to play by a guide character.

“Performance information” is any information relating to a performance of a musical instrument by a user. For example, evaluation information representing the result of evaluating the performance of the musical instrument by the user is exemplified as performance information. Evaluation information is, for example, information representing a user's performance error. Information representing a performance error is, for example, information such as the importance of the performance error, the position of the performance error in a musical piece, the type of the performance error, and the specific content of the performance error. In addition, video data generated by photographing a performance by the user, and audio data generated by collecting sounds of a performance of a musical instrument by a user, are also exemplified as “performance information.” “Acquisition” of the performance information encompasses both an action of receiving performance information generated by an external device and an action of generating the performance information by oneself.

The “guide character” is a virtual object (agent) displayed on the display device. A specific example of a guide character would be a virtual living being such as a human being or an animal, but a “guide character” can also encompass non-biological objects such as robots. “Control of the action of the guide character” is a control process for causing the guide character to execute an action in accordance with the response information. For example, a process for causing the guide character to execute an action of speaking the response information is exemplified.

“Notification action” is an output action for notifying the user of the response information. Examples of “notification actions” include a process of displaying response information on a display device, a process of reproducing voice represented by the response information, a process of causing a virtual guide character to act in accordance with the response information, a process of displaying a musical score of a section of a musical piece specified by the response information, and a process of reproducing the performance of said section.

In a specific example (aspect 2) of aspect 1, in the acquisition of the response information, a prompt including the performance information is generated, and the response information generated by a trained generative model in response to the prompt is acquired. In the aspect described above, a prompt including performance information relating the performance of a musical instrument by a user is generated, and response information in natural language generated by a trained model in response to the prompt is acquired. Accordingly, it is possible to notify the user of a statistically valid and linguistically natural response information, with respect to information (for example, evaluation) relating to the performance of the musical instrument by the user.

A “prompt” is input information forming the basis for a trained model to generate response information. A “prompt” can also be expressed as an instruction for the generation of the response information by a trained generative model, or an instruction relating to the response information that said generative model should generate. A “prompt” includes both a single prompt and a collection of a plurality of prompts.

“Response information in natural language” is information in which a response to a prompt is expressed in natural language. Specifically, a response sentence in natural language corresponding to the performance information is generated as “response information.” For example, a response sentence for instructing or guiding a user in accordance with performance information included in the prompt is an example of the response information. “Acquisition” of response information encompasses both an action of receiving performance information generated by an external device that includes a generative model, and an action of generating performance information by oneself using a generative model.

In a specific example (aspect 3) of aspect 2, the performance information includes evaluation information representing an evaluation relating to the performance. In addition, in a specific example (aspect 4) of aspect 3, the evaluation information includes at least one or more of the type of performance error that occurred in the performance, the importance of the performance error, the position of the performance error in a musical piece, or the content of the performance error. According to the aspect described above, since various information relating to performance errors is included in the performance information, it is possible to generate response information that includes various information relating to performance errors.

In a specific example (aspect 5) of any one of aspects 2 to 4, the prompt includes an instruction to include, in the response information, identification information of a performance error that occurred in the performance. According to the aspect described above, response information including identification information of a performance error is generated by a generative model. Accordingly, it is possible to easily check, using the identification information, whether all of the performance errors specified in the prompt are included in the response information.

In a specific example (aspect 5) of any one of aspects 2 to 5, the prompt includes an attribute of the user. According to the aspect described above, since the prompt includes an attribute of the user, a variety of response information can be generated in accordance with the attribute of the user.

An “attribute of the user” includes, for example, age, sex, generation, occupation, personality (kind personality, assertive personality, etc.), emotion (angry, sad, etc.), and the like. In addition, the skill level (beginner, intermediate, advanced) with respect to playing the musical instrument is also included in the “attribute of the user.”

In a specific example (aspect 7) of any one of aspects 2 to 6, the prompt includes an attribute of a virtual respondent that responds with the response information. According to the aspect described above, since the prompt includes an attribute of a virtual respondent, a variety of response information can be generated in accordance with said attribute.

An “attribute of the respondent” includes, for example, age, sex, generation, occupation, personality (kind personality, assertive personality, etc.), emotion (angry, sad, etc.), and the like. In addition, the skill level (beginner, intermediate, advanced) with respect to instructing musical performances is also included in the “attribute of the respondent.”

In a specific example (aspect 8) of any one of aspects 2 to 7, the prompt includes a tone of voice relating to the response information. According to the aspect described above, since the prompt includes the tone of voice relating to the response information, a variety of response information can be generated.

“Tone of voice” is the tone of the words or phrases represented by the response information. For example, the mood (tone) of a word or phrase, emotion, etc., are encompassed in “tone of voice.” Examples of “mood” include gentle tone, strict tone, stiff tone, formal tone, frank tone, and the like. In addition, examples of “emotion” include angry tone, sad tone, and fun tone. In addition to the mood or emotion exemplified above, “tone of voice” also encompasses “speech habit,” “dialect,” and the like. “Speech habit” is a phrase that is frequently uttered. For example, adding specific words (e.g., “. . . meow,” “. . . woof,” etc.) to the end of a sentence is an example of “speech habit.” “Dialect” is a local variation of a particular language.

In a specific example (aspect 9) of any one of aspects 1 to 8, the response information specifies an action that should be executed in the process of notifying the response information, and in the notification action, the guide character is caused to execute an action specified in the response information. According to the aspect described above, the guide character executes various actions in the notification action. Accordingly, it is possible to diversify the actions of the guide character.

“Action that should be executed in the process of notifying the response information” is an auxiliary action of the guide character that is not directly related to the performance information, for example. For example, various actions that could be executed by a real instructor in the process of instructing how to play, such as an action of gazing at the user, an action of gazing at a musical instrument in virtual space, and a smiling action, are exemplified as an “action that should be executed in the process of notifying the response information.”

In a specific example (aspect 10) of any one of aspects 1 to 9, appropriateness of the response information is determined, and the notification action is executed when it is determined that the response information is appropriate. According to the aspect described above, the notification action is executed when it is determined that the response information is appropriate. Accordingly, compared to a configuration in which the notification action is unconditionally executed, the possibility that an inappropriate response information is notified to the user can be reduced.

To “determine the appropriateness of the response information” includes, in addition to determining whether the response information is appropriate for the prompt, determining whether the response information is appropriate from an educational or social perspective. An example of the former determination is determining whether all of the performance information included in the prompt is reflected in the response information. An example of the latter determination is determining whether educationally or socially inappropriate word or phrase is included in the response information.

An information processing method according to one aspect (aspect 11) of the present disclosure comprises: acquiring performance information relating to a performance of a musical instrument by a user; and generating a prompt for causing a trained generative model to generate response information in natural language, the prompt including the performance information. According to the aspect described above, a prompt is generated including performance information relating to a performance of a musical instrument by a user. Accordingly, it is possible to generate statistically valid and linguistically natural response information, with respect to performance information relating to the performance of the musical instrument by the user. In addition, it is possible to provide the user with a unique customer experience of obtaining statistically valid and linguistically natural response information with respect to performance information.

An information processing system according to one aspect (aspect 12) of the present disclosure comprises an information acquisition unit for acquiring performance information relating to a performance of a musical instrument by a user, a response acquisition unit for acquiring response information in natural language corresponding to the performance information, and an action control unit for causing a guide character displayed on a display device to execute a notification action for notifying the response information.

A program according to one aspect (aspect 13) of the present disclosure causes a computer system to function as an information acquisition unit for acquiring performance information relating to a performance of a musical instrument by a user, a response acquisition unit for acquiring response information in natural language corresponding to the performance information, and an action control unit for causing a guide character displayed on a display device to execute a notification action for notifying the response information.

What is claimed is:

1. An information processing method realized by a computer system, the method comprising:
acquiring performance information relating to a performance of a musical instrument by a user;
acquiring response information in natural language corresponding to the performance information; and
executing a notification action for notifying the response information by a guide character displayed on a display device.

2. The information processing method according to claim 1, wherein
in the acquiring of the response information,
a prompt including the performance information is generated, and
the response information generated by a trained generative model in response to the prompt is acquired.

3. The information processing method according to claim 2, wherein
the performance information includes evaluation information representing an evaluation relating to the performance.

4. The information processing method according to claim 3, wherein
the evaluation information includes at least one or more of a type of a performance error occurred in the performance, a degree of importance of the performance error, a position of the performance error in a musical piece, or content of the performance error.

5. The information processing method according to claim 2, wherein
the prompt includes an instruction to include, in the response information, identification information of a performance error occurred in the performance.

6. The information processing method according to claim 2, wherein the prompt includes an attribute of the user.

7. The information processing method according to claim 2, wherein
the prompt includes an attribute of a virtual respondent that responds with the response information.

8. The information processing method according to claim 2, wherein
the prompt includes a tone of voice relating to the response information.

9. The information processing method according to claim 1, wherein
the response information specifies an action that is to be executed in the notifying of the response information, and
in the executing of the notification action, the guide character is caused to execute the action specified by the response information.

10. The information processing method according to claim 1, further comprising
determining appropriateness of the response information, wherein
the notification action is executed upon determining that the response information is appropriate.

11. An information processing method realized by a computer system, the method comprising:
acquiring performance information relating to a performance of a musical instrument by a user; and
generating a prompt for causing a trained generative model to generate response information in natural language, the prompt including the performance information.

12. An information processing system comprising:
an electronic controller including one or a plurality of processors, the electronic controller being configured to
acquire performance information relating to a performance of a musical instrument by a user,
acquire response information in natural language corresponding to the performance information, and
cause a guide character displayed on a display device to execute a notification action for notifying the response information.
